(19) United States
(12) Patent Application Publication
(10) Pub. No.: US 2009/0220686 A1
(43) Pub. Date: Sep. 3, 2009

(54) COMPRESSED AIR SPRAY GLUE GUN

(76) Inventor: Corey Minion, Cleveland Heights, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/040,145

(22) Filed: Feb. 29, 2008

(51) Int. Cl. B05D 5/10; B05C 5/00

(52) U.S. Cl. 427/207.1; 118/300

(57) ABSTRACT

An adhesive spray gun is provided for spraying an adhesive material into a web-like pattern over a substantial distance. The spray gun comprises an adhesive pathway for receiving an adhesive material and a heating element for melting the adhesive material into an adhesive stream. The spray gun further comprises an air pathway for an airstream, and a nozzle including ends of the adhesive pathway and the air pathway. The adhesive pathway and the air pathway are configured within the nozzle such that the air stream and adhesive stream exit the nozzle in a substantially laminar direction relative to one another. By providing an air stream flowing substantially laminar to the adhesive stream, in accordance with the Venturi Effect, a bead of adhesive is drawn from the adhesive stream into the air stream. The bead of adhesive is strewn and extended into a fine strand which may travel over a substantial distance to achieve a web-like pattern on the surface of impact.

### TECHNICAL FIELD OF THE INVENTION

The technology of the present disclosure relates generally to a compressed air glue gun, and more particularly to a compressed air glue gun for spraying an adhesive material in thin, web-like strands over a substantial distance.

### DESCRIPTION OF THE RELATED ART

Horrible hauntings creep into our common experience from time to time, and no place of dread would be complete without webs strewn generously throughout. From the dusty, sticky cobwebs to the abodes of eerie spiders, great and small, well-placed webs contribute to the frightening atmosphere.

Those who would scare us, therefore, have developed various ways of reproducing web-like structures for television and movie sets, haunted houses, amusement park attractions, Halloween decorations, and the like. Typically, web decorations are formed by adhering a fine, thread-like fabric to ceilings and walls. To do so, however, often has proven difficult and time consuming. The threads may be strewn about by hand, and in high or hard-to-reach places, ladders or similar elevation equipment may be necessary. Placing web decorations, therefore, can be dangerous as well as difficult and time consuming.

Glue guns are known in the art and typically are used in construction related industries for fastening materials together by coating surfaces with adhesive materials. Some of such devices may incorporate the injection of air into the adhesive to facilitate application. Sometimes, the injection of air may contribute to producing spiral or swirl patterns to more broadly and evenly coat surfaces as desired. Because of the use in construction or crafts, the swirls or spiral patterns of prior art glue guns tend to be relatively thick to provide for a more even surface coverage. In addition, the glue tends to be applied to surfaces adjacent the user so that adhesion to other objects may be promptly achieved. For these reasons, prior art glue guns may not be used for the decorative applications in which fine, web-like strands may need to be applied to surfaces at distances which may be many feet from the user.

### SUMMARY

Accordingly, there is a need in the art for an improved mechanism and method for providing web-like decorations. The web patterns are formed by the spraying of a glue or other adhesive in fine strands, which adhere to any surface upon which the sprayed adhesive impacts. To achieve this result, a spray gun for spraying an adhesive material comprises an adhesive pathway for receiving an adhesive material. A heating element melts the adhesive material into an adhesive stream, which flows within the adhesive pathway. The spray gun further comprises an air pathway for an air stream, and a nozzle comprising an end of the adhesive pathway and an end of the air pathway. The adhesive pathway and the air pathway are configured within the nozzle such that the air stream and adhesive stream exit the nozzle in a substantially laminar direction relative to one another.

In exemplary embodiments, the adhesive is a conventional glue stick as may be used in an ordinary glue gun. In addition, the air stream comprises a compressed air stream. By providing an air stream flowing substantially laminar to the adhesive stream, the device takes advantage of the Venturi Effect to create a web-like spray of adhesive. The adhesive stream flows with a pressure differential relative to the pressure of the rapidly flowing air stream. In accordance with the Venturi Effect, a bead of glue is drawn from the adhesive stream across the pressure differential into the adjacent air stream. By virtue of the air velocity, beads of glue are strewn into fine strands which may travel over a substantial distance. Applicant has found that a spray distance of over one foot is typical, and a spray distance as far as forty to fifty feet may be readily achieved.

In other exemplary embodiments, the air stream may be heated, and, for example, may be heated by the same heating element that melts the adhesive. In this manner, the air does not immediately act to cool the adhesive upon contact. Because the adhesive remains substantially molten when exiting the nozzle, the Venturi Effect is enhanced because the less solidified the adhesive, the more finely a bead can be drawn into a strand. The adhesive also may remain more viscous over its distance of travel, which improves adhesion to the surface upon which it lands.

Therefore, according to one aspect of the invention, a spray gun for spraying an adhesive material comprises an adhesive pathway for receiving the adhesive material, a heating element for melting the adhesive material into an adhesive stream which flows within the adhesive pathway, and an air pathway for an air stream. A nozzle comprises an end of the adhesive pathway and an end of the air pathway, wherein the adhesive pathway and the air pathway are configured at the nozzle such that the air stream and adhesive stream exit the nozzle in a substantially laminar direction relative to one another.

According to one embodiment of the spray gun, at least a portion of the air pathway is adjacent the heating element such that the heating element heats the air stream.

According to one embodiment of the spray gun, the spray gun has a power rating, and an angle of attack of the laminar air stream against the adhesive stream exiting the nozzle decreases as the power rating of the spray gun decreases.

According to one embodiment of the spray gun, the spray gun has a power rating of at least eighty watts and the air stream and the adhesive stream exit the nozzle parallel to one another.

According to one embodiment of the spray gun, the spray gun has a power rating of at least five-hundred watts and the angle of attack of the air stream against the adhesive stream exiting the nozzle is at least 30 degrees.

According to one embodiment of the spray gun, the air pathway exits the nozzle at a location downstream from where the adhesive pathway exits the nozzle.

According to one embodiment of the spray gun, the adhesive material is a glue.

According to one embodiment of the spray gun, the spray gun further comprises a trigger for controlling the flow rate of the adhesive stream through the adhesive pathway.

According to one embodiment of the spray gun, the spray gun further comprises a first air valve for controlling the flow rate of air through the air pathway.

According to one embodiment of the spray gun, the trigger controls the operation of the first air valve to control the flow rate of air through the air pathway.

According to one embodiment of the spray gun, the spray gun further comprises a second air valve, which when in an open position, permits the air stream to enter the air pathway from an air source.

According to another aspect of the invention, a method of spraying an adhesive material in a web pattern comprises the steps of heating the adhesive material to a melted state, creating an adhesive stream of the melted adhesive material, and applying an air stream adjacent the adhesive stream, whereby the air stream and adhesive stream flow substantially laminar to one another such that the adhesive stream is drawn into the air stream.

According to one embodiment of the method, the adhesive stream flows at a pressure differential relative to the pressure of the air stream.

According to one embodiment of the method, the air stream flows at a rapid velocity relative to the velocity of the adhesive stream such that the adhesive stream is drawn into the air stream in the form of a fine strand.

According to one embodiment of the method, the drawn-in adhesive material is carried by the air stream a distance of at least one foot.

According to one embodiment of the method, the drawn-in adhesive material is carried by the air stream a distance of at least forty feet.

According to one embodiment of the method, the method further comprises heating the air stream prior to applying the air stream adjacent the adhesive stream.

According to one embodiment of the method, the adhesive and the air stream are heated simultaneously by a common heating element.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a cross-sectional side view of an exemplary spray glue gun for use in accordance with an embodiment of the present invention.

FIG. 2 is a side view of the spray glue gun of FIG. 1 depicting an exemplary configuration of an air pathway for use with the spray glue gun.

FIG. 3 depicts an exemplary nozzle portion of the spray glue gun of FIG. 1

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

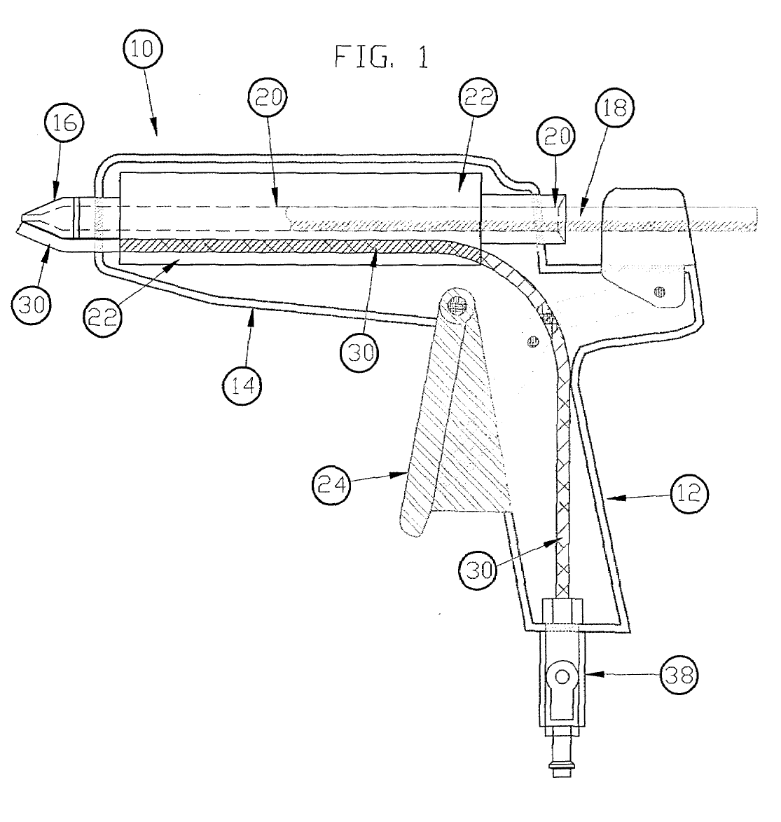

FIG. 1 depicts a side cross-sectional view of an exemplary spray glue gun 10 in accordance with embodiments of the present invention. Many portions of the glue gun are conventional and therefore are not described in great detail. Indeed, one of the advantages of the present invention is that the inventive features may be incorporated into various glue guns currently available. The spray glue gun may include a handle 12, a body 14, and a nozzle 16. An adhesive stick 18 may be received within an adhesive pathway 20 within the body to provide a source of adhesive material. The adhesive stick may be any conventional adhesive or glue as are known in the art. A heating element 22 may be adjacent the adhesive or glue stick to melt the adhesive into an adhesive stream. In the depicted embodiment, the heating element 22 circumscribes the adhesive stick to provide for more even heating and melting. Power may be provided with a conventional power cord and power supply as are known in the art. Glue gun 10 also may include a trigger mechanism 24. A user may depress the trigger mechanism, which forces the melted adhesive from the upstream portion of the adhesive pathway 20 into the nozzle 16.

Glue gun 10 also may include an air pathway 30 in communication with a compressed air source (not shown). In the depicted embodiment, the air pathway 30 runs along the body 14 to the nozzle 16. As further described below, the configuration of the air stream in the manner disclosed herein permits a conventional glue gun to be modified for spraying fine strands of adhesive material over considerable distances, as may be desirable for creating decorative, web-like configurations and the like.

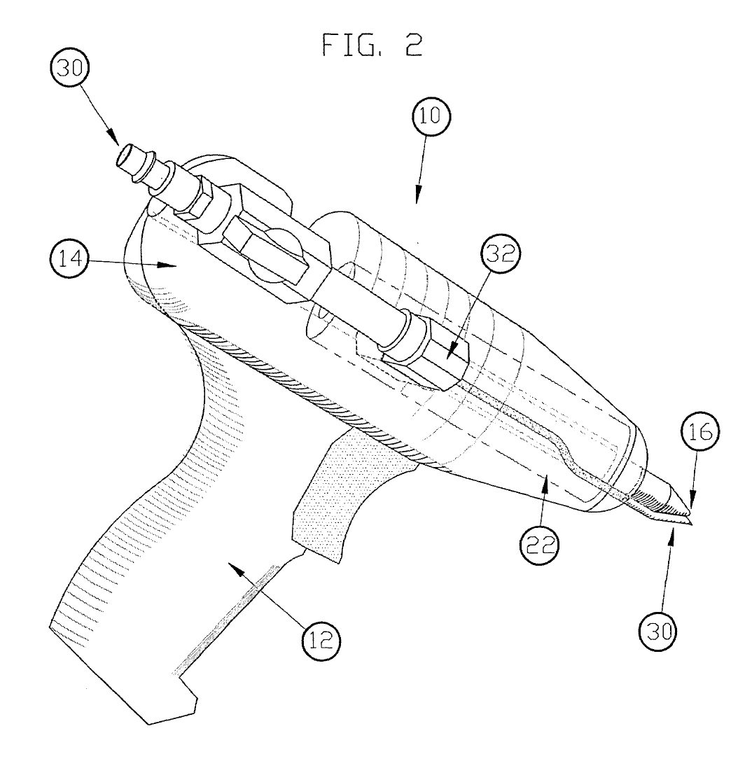

FIG. 2 depicts a side view of the glue gun 10 of FIG. 1. Referring to FIGS. 1 and 2, an exemplary configuration of the air pathway is shown. As seen in FIG. 2, the air pathway 30 may run along a portion of the outside of body 14 of the glue gun. At junction 32, the air pathway may enter the glue gun and run internally within the body 14. The air pathway 30 may extend to the nozzle 16 where the air stream may exit the spray glue gun adjacent the location where the adhesive exits the nozzle. As seen in the cross-sectional view of FIG. 1, where the air pathway runs internally within the glue gun, the air flow may be adjacent the heating element 22. As further described below, this configuration permits simultaneous heating of the adhesive and air stream by a common heating element.

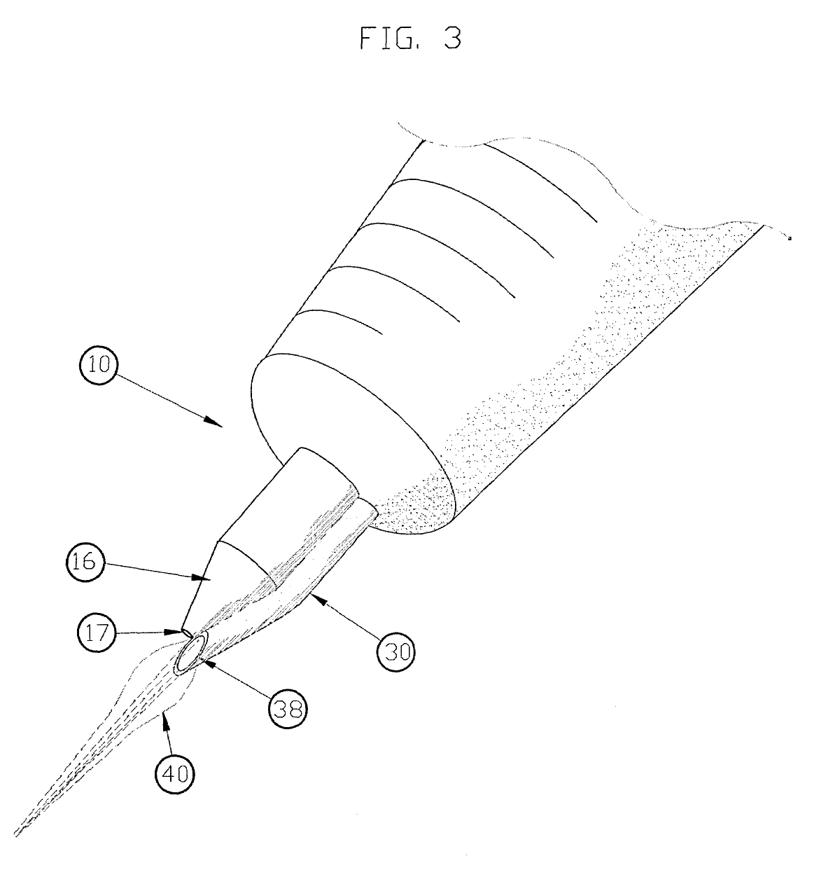

FIG. 3 depicts an exemplary configuration of the end portion of the glue gun 10 containing the nozzle 16. The nozzle 16 includes a downstream portion of the adhesive pathway 20 and may possess a conical shape. Melted adhesive flows from the upstream portion of the adhesive pathway into the nozzle, and the adhesive may exit the nozzle through an adhesive exit 17. The conical shape of the nozzle portion of the adhesive pathway permits the glue to be deposited in beads or droplets comparable in size to the diameter of the adhesive exit 17. The nozzle 16 also may include an end portion of the air pathway 30, which terminates at an air exit 36 adjacent the adhesive exit 17. As can be seen in FIG. 3, the air pathway 30 is configured such that at the air exit 36, the direction of the air stream is substantially laminar relative to the direction of the adhesive stream exiting from the adhesive exit 17. As further described below, this laminar configuration results in the production of fine strands of adhesive being strewn from the glue gun, and the strands may travel over a substantial distance from the user.

An exemplary operation of the glue gun 10 will now be described. A user may insert a glue or other adhesive stick into the adhesive passage 20 as is conventional for a glue gun. When the glue gun is powered, heating element 22 melts the adhesive until it flows in an adhesive stream as a viscous liquid. By depressing the trigger mechanism 24, the melted adhesive is forced through the adhesive passage 20 to the nozzle 16, where the adhesive leaves the nozzle through the adhesive exit 17 as a series of beads or droplets. It will be appreciated that the user may control the amount and rate of the adhesive exiting the nozzle by varying the manual pressure applied to the trigger mechanism.

Referring again to FIG. 1, air flow may be controlled independently of the adhesive flow by manually operating a first air valve 38. Alternatively, the rate of air flow may be controlled simultaneously with the adhesive flow with the trigger mechanism 24. The air stream may flow through the air pathway 30 passed the heating element 22, whereby the air is heated simultaneously with the adhesive stream. The air stream continues to flow through the air pathway 30 to the nozzle 16, where the air leaves the glue gun through the air exit 36. Compressed airflow may be initiated by opening a second air valve 39 located between the spray gun 10 and a compressed air source (not shown).

As stated above, where the adhesive stream and air stream exit the nozzle, the air and adhesive pathways are configured to be substantially laminar relative to one another. By configuring the pathways in this manner, the adhesive stream and air stream interact pursuant to the “Venturi Effect”, which is a principle that governs the interaction of two streams of fluid flowing adjacent one another. Generally, as those skilled in the art understand, a pressure differential across two fluid streams would tend to equalize. Pursuant to the Venturi Effect, a fluid flowing in a stream at a relatively high pressure is passed through a restrictive orifice; the downstream side of the orifice has greater volume sustaining a pocket of low pressure to draw in the adjacent fluid stream at a comparatively high pressure trying to attain equilibrium. In the glue gun disclosed herein, the adhesive stream exits the glue gun with a pressure differential relative to the pressure of the fast-moving air stream. Beads of adhesive from the adhesive stream, therefore, are gradually drawn into the adjacent air stream across the pressure differential. Furthermore, because the air is moving at a high velocity, the adhesive beads are stretched or extended as they are drawn into the air stream. The result is that the adhesive beads are strewn into fine strands blown out from the glue gun via the air stream. As seen in FIG. 3, the air exit 36 may be slightly upstream in the nozzle from the adhesive exit 17. This slight offset facilitates the Venturi Effect and improves the stretching effect of the adhesive beads being drawn into the air stream.

Applicant has found that the adhesive strands may typically be applied at distances greater than one foot, and readily blown as far as forty to fifty feet, and perhaps farther. In addition, because the adhesive is strewn into fine strands pursuant to the Venturi Effect, the strands form a web-like pattern on the surfaces of impact to which the adhesive adheres. It remains pliant to follow and adhere to minute surface contours. As the adhesive travels, it may cool somewhat but remains sufficiently viscous to stick to the surface of impact, upon which the adhesive dries. By applying continuous pressure to the trigger, the web strands may be deposited upon considerable portions of wall and ceiling surfaces, or other objects. The device, therefore, provides a convenient, time-saving manner by which to broadly create web-like patterns or decorations on surfaces at considerable distances from the user. Because no ladders or other climbing devices are required, safety is enhanced. In addition, to remove the webs one need only pull the dried glue strands from the surface. Colorings may be added to conventional glue or adhesive sticks to enhance the decorative effects.

At the end of the nozzle, the laminar configuration of the air stream relative to the adhesive stream is what permits the Venturi Effect to operate. Although certain prior art glue guns may incorporate air streams into a glue stream, they do not do so using compressed air in a laminar stream. The prior art configurations, therefore, typically may aid in depositing glue upon surfaces in close proximity and in a relatively uniform consistency. The prior art devices, however, do not employ the Venturi Effect to stretch the glue into fine strands to provide a web-like pattern on a surface located at a considerable distance from the user.

With Applicant's configuration, the thickness of the web strands and the distance of projection may be controlled. For example, by applying greater pressure to the trigger mechanism, a thicker adhesive stream may be created, resulting in thicker strands of the web. By increasing the velocity of the air stream with the air valves, the distance of projection may be increased, as will be the level of stretching of the adhesive beads resulting in a finer strand. The reverse also applies

Applicant has also found that for a glue gun having a high power rating, the angle of attack 40 (see FIG. 3) of the air stream against the adhesive stream may be steepened to enhance the web effect, although the laminar component of the angle of attack remains substantial. Angles of attack from about zero degrees (nearly parallel streams) to about 30 degrees work well depending upon the power of the glue gun. For example, with a 500 watt glue gun, the angle of attack is about 30 degrees. In contrast, for an 80 watt glue gun, for example, the adhesive stream and air stream are nearly parallel when exiting the nozzle.

In an exemplary embodiment, as stated above, the air stream is heated additionally to the adhesive stream. The air stream may be heated by the same heating element that heats the adhesive stream by configuring at least a portion of the air pathway 30 to flow adjacent the heating element 22 (see FIG. 1). By heating the air stream, one decreases the cooling effect the air might otherwise have when the air contacts the melted adhesive stream, which enhances the Venturi Effect by maintaining the molten nature of the adhesive beads at the nozzle.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A spray gun for spraying an adhesive material comprising:
an adhesive pathway for receiving the adhesive material;
a heating element for melting the adhesive material into an adhesive stream which flows within the adhesive pathway;
an air pathway for an air stream; and
a nozzle comprising an end of the adhesive pathway and an end of the air pathway, wherein the adhesive pathway and the air pathway are configured at the nozzle such that the air stream and adhesive stream exit the nozzle in a substantially laminar direction relative to one another.

2. A spray gun according to claim 1, wherein at least a portion of the air pathway is adjacent the heating element such that the heating element heats the air stream.

3. A spray gun according to claim 1, wherein the spray gun has a power rating, and an angle of attack of the laminar air stream against the adhesive stream exiting the nozzle decreases as the power rating of the spray gun decreases.

4. A spray gun according to claim 3, wherein the spray gun has a power rating of at least eighty watts and the air stream and the adhesive stream exit the nozzle parallel to one another.

5. A spray gun according to claim 3, wherein the spray gun has a power rating of at least five-hundred watts and the angle of attack of the air stream against the adhesive stream exiting the nozzle is at least 30 degrees.

6. A spray gun according to claim 1, wherein the air pathway exits the nozzle at a location downstream from where the adhesive pathway exits the nozzle.

7. A spray gun according to claim 1, wherein the adhesive material is a glue.

8. A spray gun according to claim 1 further comprising a trigger for controlling the flow rate of the adhesive stream through the adhesive pathway.

9. A spray gun according to claim 8 further comprising a first air valve for controlling the flow rate of air through the air pathway.

10. A spray gun according to claim 9, wherein the trigger controls the operation of the first air valve to control the flow rate of air through the air pathway.

11. A spray gun according to claim 10 further comprising a second air valve, which when in an open position, permits the air stream to enter the air pathway from an air source.

12. A method of spraying an adhesive material in a web pattern comprising the steps of:
heating the adhesive material to a melted state;
creating an adhesive stream of the melted adhesive material; and
applying an air stream adjacent the adhesive stream, whereby the air stream and adhesive stream flow substantially laminar to one another such that the adhesive stream is drawn into the air stream.

13. A method of spraying an adhesive material according to claim 12, wherein the adhesive stream flows at a pressure differential relative to the pressure of the air stream.

14. A method of spraying an adhesive material according to claim 13, wherein the air stream flows at a rapid velocity relative to the velocity of the adhesive stream such that the adhesive stream is drawn into the air stream in the form of a fine strand.

15. A method of spraying an adhesive material according to claim 14, wherein the drawn-in adhesive material is carried by the air stream a distance of at least one foot.

16. A method of spraying an adhesive material according to claim 15, wherein the drawn-in adhesive material is carried by the air stream a distance of at least forty feet.

17. A method of spraying an adhesive material according to claim 11 further comprising heating the air stream prior to applying the air stream adjacent the adhesive stream.

18. A method of spraying an adhesive material according to claim 17, wherein the adhesive and the air stream are heated simultaneously by a common heating element.
